(19) United States
(12) Patent Application Publication
(10) Pub. No.: US 2025/0346008 A1
(43) Pub. Date: Nov. 13, 2025

(54) TIRE BELT MANUFACTURING APPARATUS

(71) Applicant: Toyo Tire Corporation, Itami-shi (JP)

(72) Inventor: Junji Itakura, Itami-shi (JP)

(73) Assignee: Toyo Tire Corporation, Itami-shi (JP)

(21) Appl. No.: 19/191,016

(22) Filed: Apr. 28, 2025

(30) Foreign Application Priority Data
May 13, 2024 (JP) 2024-077694

(51) Int. Cl. B29D 30/42

(52) U.S. Cl. CPC B29D 30/42; B29D 2030/421

(57) ABSTRACT

A tire belt manufacturing apparatus of the present invention includes a joining table on which a parallelogram rubber member is to be placed and that moves the rubber member to a front side in a first direction, and a joining device that joins sides of the rubber members. A conveyer that conveys the rubber member to a back side of a joining position in the first direction in the joining table includes a plurality of conveyer belts, and the plurality of conveyer belts is disposed in such a stepwise manner that the conveyer belt disposed closer to one side in a second direction is located closer to the front side in the first direction.

### BACKGROUND OF THE INVENTION

### 1. Field of the Invention

The present invention relates to a tire belt manufacturing apparatus.

### 2. Description of Related Art

A pneumatic tire belt is one obtained by covering, with rubber, a plurality of cords extending diagonally with respect to a tire circumferential direction. This tire belt is manufactured from an elongated member called a raw belt obtained by covering a plurality of cords with rubber. The direction of extension of the cord of the raw belt is coincident with the longitudinal direction of the raw belt.

In manufacturing of the tire belt, for example, the raw belt is first cut diagonally with respect to the longitudinal direction (i.e., the direction of extension of the cord) of the raw belt, as described in JP2007-125895A. In this manner, a parallelogram rubber member is formed, which includes cut sides formed by cutting and uncut sides which are sides of the raw belt. The resultant rubber member is conveyed by a conveyer to come into contact with an uncut side of a rubber member cut previously, and thereafter, the sides of these rubber members are joined to each other. In this manner, the elongated tire belt is manufactured.

Then, the elongated tire belt is cut into a predetermined length corresponding to the circumferential length of a tire, and is bonded in an unvulcanized state together with tire components such as an inner liner, a sidewall, a bead, and a tread. In this manner, a green tire is formed (see, e.g., JP2007-125895A).

### SUMMARY OF THE INVENTION

The rubber member cut from the raw belt has a tapered shape acute-angled on the front side in the conveyance direction of the conveyer. This leads to a problem that drive force from the conveyer is not transmitted to such a tapered front portion and the front portion of the rubber member is likely to be misaligned.

The present invention has been made in view of the above-described situation, and an object thereof is to provide a tire belt manufacturing apparatus capable of conveying the rubber member while reducing misalignment of the front portion of the rubber member.

The present invention includes the following embodiments.

[1]A tire belt manufacturing apparatus including a joining table on which a parallelogram rubber member is to be placed and that moves the rubber member to a front side in a first direction, and a joining device that joins sides of the rubber members, in which
the joining device joins a side of the rubber member, which is placed on the front side of a joining position set for the joining table in the first direction, on a back side in the first direction to a side of the rubber member, which is placed on the back side of the joining position in the first direction, on the front side in the first direction to manufacture a tire belt,
the joining table includes a conveyer that moves the rubber member to the front side in the first direction and conveys the rubber member to the back side of the joining position in the first direction, and a support unit that supports the rubber member placed on the front side of the joining position in the first direction, and
the conveyer includes a plurality of conveyer belts extending in the first direction and provided side by side in a second direction perpendicular to the first direction, and the plurality of conveyer belts is disposed in such a stepwise manner that the conveyer belt disposed closer to one side in the second direction is located closer to the front side in the first direction.

[2] The tire belt manufacturing apparatus according to [1] above, in which the plurality of conveyer belts is driven by an identical drive device.

[3] The tire belt manufacturing apparatus according to [1] or [2] above, in which the conveyer includes, for each of the plurality of conveyer belts, pulleys disposed at both end portions of a conveyance unit that conveys the rubber member, and the plurality of conveyer belts has an identical pulley diameter.

[4] The tire belt manufacturing apparatus according to any one of [1] to [3] above, in which the rubber member placed on the front side of the joining position in the first direction is disposed so as to cover part of the plurality of conveyer belts in a width direction.

[5] The tire belt manufacturing apparatus according to any one of [1] to [4] above, in which the conveyer includes a plurality of suction units that sucks the rubber member at intervals in the first direction, and the suction units are more densely provided on the front side in the first direction than on the back side in the first direction.

[6] The tire belt manufacturing apparatus according to any one of [1] to [5] above, in which the conveyer includes, for each of the plurality of conveyer belts, pulleys disposed at both end portions of a conveyance unit that conveys the rubber member, and each of the pulleys has a greater diameter at a center portion in a rotation axis direction than at both end portions in the rotation axis direction.

The present invention has the above-described features, and therefore, the drive force of the conveyer belt can also be transmitted to a front end portion of the parallelogram rubber member and the rubber member can be conveyed while misalignment of the rubber member is reduced.

### BRIEF DESCRIPTION OF THE DRAWINGS

FIG. 1 is a plan view of the entirety of a tire belt manufacturing apparatus of one embodiment of the present invention;

FIG. 2 is a plan view of a joining table;

FIG. 3 is a view of the joining table from the direction of an arrow A of FIG. 2;

FIG. 4A is a side view of a first conveyer forming the joining table;

FIG. 4B is a side view of a second conveyer forming the joining table;

FIG. 4C is a side view of a third conveyer forming the joining table; and

FIG. 4D is a side view of a fourth conveyer forming the joining table.

### DESCRIPTION OF EMBODIMENTS

An embodiment will be described based on the drawings. Note that the embodiment described below is merely one example and the scope of the present invention includes changes made as necessary without departing from the gist of the present invention.

### (1) Overall Configuration of Tire Belt Manufacturing Apparatus 10

A tire belt manufacturing apparatus 10 (hereinafter also referred to as a manufacturing apparatus 10) manufactures a tire belt B by cutting a raw belt 1, which is obtained by covering a reinforcement cord formed of a plurality of steel cords or organic fiber cords with unvulcanized rubber, diagonally with respect to the direction of extension of the reinforcement cord to form parallelogram rubber members 1a and joining uncut sides 1a1 of the resultant rubber members 1a.

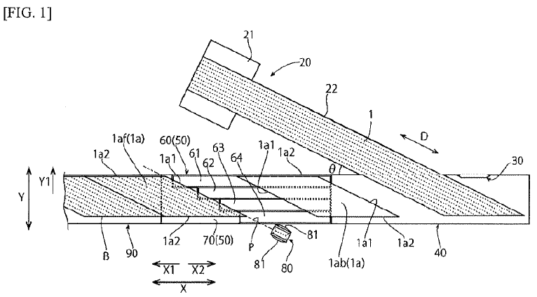

As shown in FIG. 1, the manufacturing apparatus 10 includes a supply device 20, a cutting device 30, a formation unit 40, a joining table 50, a joining device 80, and a discharge device 90.

The supply device 20 includes a supply drum 21 around which the raw belt 1 is wound, and a supply conveyer 22 that conveys the raw belt 1 pulled out of the supply drum 21 in the direction of extension of the reinforcement cord. The supply conveyer 22 is configured such that a feed length by which the raw belt 1 is intermittently conveyed is adjustable. The supply conveyer 22 intermittently supplies the raw belt 1 to the formation unit 40 at an interval of a certain length corresponding to a belt width.

The cutting device 30 cuts the raw belt 1, which has been conveyed to the formation unit 40 side at the interval of the certain length by the supply conveyer 22, in a first direction X at a predetermined angle θ (for example, an angle θ of 15° to 30°) with respect to a conveyance direction D of conveying the raw belt 1. In this manner, the parallelogram rubber member 1a is formed on the formation unit 40, the rubber member 1a having acute-angled portions with the predetermined angle θ and including the pair of uncut sides 1a1 parallel (i.e., parallel with the sides of the raw belt 1) with the conveyance direction D and a pair of cut sides 1a2 formed by cutting the raw belt 1 with the cutting device 30.

The formation unit 40 moves the rubber member 1a formed by the cutting device 30 in the first direction X in which the cutting device 30 cuts the raw belt 1. The formation unit 40 is a conveyer that conveys the rubber member 1a to the joining table 50 provided on a front side X1 of the formation unit 40 in the first direction X.

The joining table 50 moves the rubber member 1a supplied from the formation unit 40 in the first direction X such that the uncut side 1a1 of such a rubber member 1a is located at a joining position P set for the joining table 50. At the joining position P set for the joining table 50, the rubber member 1a conveyed subsequently is joined to the uncut side 1a1 of the rubber member 1a conveyed previously. Note that a detailed configuration of the joining table 50 will be described later.

The joining device 80 joins a rubber member (hereinafter, this rubber member will also be referred to as a front rubber member) 1af disposed on the front side X1 of the joining position P, which is set for the joining table 50, in the first direction X to a rubber member (hereinafter, this rubber member will also be referred to as a back rubber member) lab disposed on a back side X2 of the joining position P in the first direction X.

Specifically, the joining device 80 includes a pair of joining rollers 81 and a drive unit (not shown) that reciprocatably moves the joining rollers 81 along the uncut sides 1a1 of the rubber members 1a while rotating the joining rollers 81. The joining device 80 moves the pair of joining rollers 81 along the uncut sides 1a1 of the front rubber member 1af and the back rubber member lab disposed at the joining position P, thereby pulling end portions of both these rubber members 1a and bonding the uncut sides 1a1 in a state of the uncut sides 1a1 contacting each other. In this manner, the tire belt B is formed.

The discharge device 90 is a conveyer provided on the front side X1 of the joining table 50 in the first direction X. The joining device 80 joins the uncut sides 1a1 of the front rubber member 1af and the back rubber member lab, and thereafter, the discharge device 90 moves the tire belt B to the front side X1 in the first direction X such that the uncut side 1a1 of the tire belt B on the back side X2 in the first direction X is located at the joining position P.

### (2) Joining Table 50

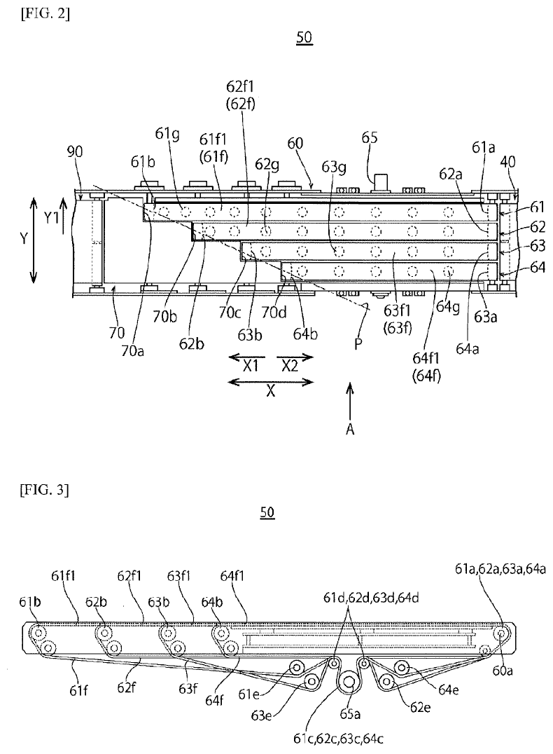

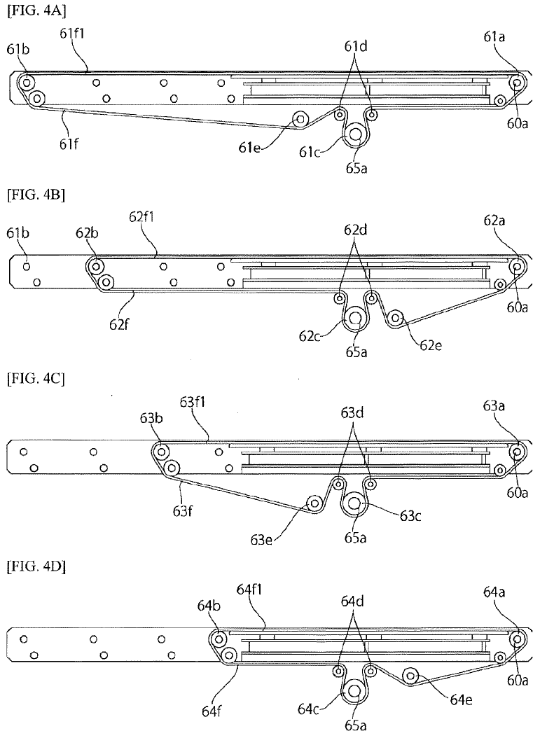

As shown in FIGS. 2 and 3, the joining table 50 includes a conveyer 60 that conveys the rubber member 1a conveyed from the formation unit 40 to the front side X1 in the first direction X, and a support unit 70 that supports the rubber member 1a disposed on the front side X1 of the joining position P in the first direction X.

### (3) Conveyer 60

The conveyer 60 includes a plurality of conveyers extending in the first direction X and provided in parallel with each other, for example four conveyers which are a first conveyer 61, a second conveyer 62, a third conveyer 63, and a fourth conveyer 64. The first conveyer 61, the second conveyer 62, the third conveyer 63, and the fourth conveyer 64 are provided side by side in this order from one side Y1 to the other side in a second direction Y perpendicular to the first direction X.

Note that the conveyer 60 may include conveyers of an arbitrary number of two or more, but the conveyer 60 preferably includes three or four conveyers in consideration of easy control of the conveyer and easy adjustment of the tension of a conveyer belt.

The first conveyer 61 includes a back pulley 61a, a front pulley 61b, a drive pulley 61c, a pair of bend pulleys 61d, an adjustment pulley 61e, a conveyer belt 61f, and a suction unit 61g.

The back pulley 61a is a pulley provided at the back end of the first conveyer 61 in the first direction X. The front pulley 61b is a pulley provided at the front end of the first conveyer 61 in the first direction X. The drive pulley 61c is a pulley connected to a drive shaft 65a of a drive device 65 such as an encoder-equipped servomotor. The pair of bend pulleys 61d is pulleys provided on both sides of the drive pulley 61c in the first direction X. The adjustment pulley 61e is a pulley provided such that the position thereof in an up-down direction is adjustable.

The conveyer belt 61f is a belt coupling the pulleys 61a, 61b, 61c, 61d, 61e. The conveyer belt 61f is, for example, a flat belt made of resin such as polyurethane. The conveyer belt 61f conveys the rubber member 1a. The conveyer belt 61f may be made of the same material as that of conveyer belts provided for the conveyers forming the formation unit 40 and the discharge device 90. The suction unit 61g sucks the rubber member 1a conveyed by the conveyer belt 61f. The drive pulley 61c, the pair of bend pulleys 61d, and the adjustment pulley 61e are disposed lower than the back pulley 61a and the front pulley 61b.

When the drive shaft 65a of the drive device 65 rotates, the power thereof is transmitted to the conveyer belt 61f via the drive pulley 61c in the first conveyer 61. Then, the conveyer belt 61f moves so as to revolve around the pulleys 61a, 61b, 61c, 61d, 61e. Accordingly, the conveyer belt 61f moving on the upper side of the back pulley 61a and the front pulley 61b between the back pulley 61a and the front pulley 61b functions as a conveyance unit 61f1 that conveys the rubber member 1a to the front side X1 in the first direction X.

The suction unit 61g includes, for example, a magnet and a vacuum suction device. The suction unit 61g includes suction units 61g provided below the conveyer belt 61f in the conveyance unit 61f1 at intervals in the first direction X. The suction unit 61g sucks and holds the rubber member 1a placed on the conveyer belt 61f, thereby preventing the rubber member 1a from moving in a direction other than the first direction X during movement of the conveyer belt 61f.

As described later, the second conveyer 62, the third conveyer 63, and the fourth conveyer 64 are different from the first conveyer 61 in the length of the conveyance unit, the position of the adjustment pulley, and the arrangement of the suction units, but have configurations similar to that of the first conveyer 61.

That is, as in the first conveyer 61, the second conveyer 62 includes a back pulley 62a, a front pulley 62b, a drive pulley 62c, a pair of bend pulleys 62d, an adjustment pulley 62e, a conveyer belt 62f, and a suction unit 62g. As in the first conveyer 61, the third conveyer 63 includes a back pulley 63a, a front pulley 63b, a drive pulley 63c, a pair of bend pulleys 63d, an adjustment pulley 63e, a conveyer belt 63f, and a suction unit 63g. As in the first conveyer 61, the fourth conveyer 64 includes a back pulley 64a, a front pulley 64b, a drive pulley 64c, a pair of bend pulleys 64d, an adjustment pulley 64e, a conveyer belt 64f, and a suction unit 64g.

As shown in FIG. 3, the first conveyer 61, the second conveyer 62, the third conveyer 63, and the fourth conveyer 64 are supported at the back pulleys 61a, 62a, 63a, 64a by a common support shaft 60a. The first conveyer 61, the second conveyer 62, the third conveyer 63, and the fourth conveyer 64 are provided with the positions of the rear ends thereof in the first direction X aligned with each other.

The front pulleys 61b, 62b, 63b, 64b are different from each other in a position in the first direction X. Specifically, the front pulley 61b of the first conveyer 61 is disposed closest to the front side X1 (discharge device 90 side) in the first direction X, and the front pulley 62b of the second conveyer 62, the front pulley 63b of the third conveyer 63, and the front pulley 64b of the fourth conveyer 64 are disposed such that a distance from the discharge device 90 gradually increases in this order.

That is, in the first conveyer 61, the second conveyer 62, the third conveyer 63, and the fourth conveyer 64, the lengths of the conveyance units 61f1, 62f1, 63f1, 64f1 that convey the rubber member 1a in the first direction X gradually decreases in this order. The first conveyer 61, the second conveyer 62, the third conveyer 63, and the fourth conveyer 64 are disposed in a stepwise manner in plan view such that the conveyer disposed closer to the one side Y1 in the second direction Y is located closer to the front side X1 in the first direction X.

The back pulleys 61a, 62a, 63a, 64a and the front pulleys 61b, 62b, 63b, 64b each have such an arc sectional shape that a center portion thereof in a rotation axis direction has a greater diameter than those of both end portions and the diameter thereof gradually decreases toward both end portions. As one example of the dimensions of the back pulleys 61a, 62a, 63a, 64a and the front pulleys 61b, 62b, 63b, 64b, in a case where the diameter of the center portion in the axial direction is 50 mm and the length (width) in the axial direction is 80 mm, the diameter at both end portions in the axial direction can be set to 49.0 mm or more and 49.8 mm or less.

Any of the drive pulleys 61c, 62c, 63c, 64c is connected to the drive shaft 65a of the drive device 65, and the first conveyer 61, the second conveyer 62, the third conveyer 63, and the fourth conveyer 64 are driven by the same drive device 65.

All the back pulleys 61a, 62a, 63a, 64a and the front pulleys 61b, 62b, 63b, 64b have the same outer diameter. Moreover, all the drive pulleys 61c, 62c, 63c, 64c also have the same outer diameter. Thus, the first conveyer 61, the second conveyer 62, the third conveyer 63, and the fourth conveyer 64 are the same as each other in a conveyance speed (i.e., the movement speed of each of the conveyer belts 61f, 62f, 63f, 64f).

The adjustment pulleys 61e, 62e, 63e, 64e are provided at different positions in the first direction X, and are configured such that the positions thereof in the up-down direction are adjustable independently of each other. The positions of the adjustment pulleys 61e, 62e, 63e, 64e in the up-down direction are independently changed so that the tensions of the conveyer belts 61f, 62f, 63f, 64f of the first conveyer 61, the second conveyer 62, the third conveyer 63, and the fourth conveyer 64 are adjustable independently of each other.

The suction units 61g, 62g, 63g, 64g may be provided at equal intervals in the first direction X, but as shown in FIG. 2, may be densely provided at narrower intervals on the front side X1 of the conveyance units 61f1, 62f1, 63f1, 64f1 in the first direction X than on the back side X2 in the first direction X.

### (4) Support Unit 70

As shown in FIGS. 1 and 2, the support unit 70 is provided on the front side X1 of the conveyer 60 in the first direction X, and supports the front rubber member 1af disposed on the front side X1 of the joining position P in the first direction X.

Specifically, the support unit 70 is provided in a stepwise manner in plan view so as to face the front ends of the first conveyer 61, the second conveyer 62, the third conveyer 63, and the fourth conveyer 64 in the first direction X. The support unit 70 is provided on the front side X1 of the first conveyer 61, the second conveyer 62, the third conveyer 63, and the fourth conveyer 64 in the first direction X with a clearance necessary for movement of the conveyer belts 61f, 62f, 63f, 64f.

The support unit 70 supports the front rubber member 1af, i.e., the rubber member 1af whose front uncut side 1a1 in the first direction X is joined to another rubber member 1a to form part of the tire belt B.

In the present embodiment, the joining position P is set so as to cross opposing portions 70a, 70b, 70c, 70d of the support unit 70 facing the first conveyer 61, the second conveyer 62, the third conveyer 63, and the fourth conveyer 64 in plan view.

### (5) Method for Manufacturing Tire Belt B Using Manufacturing Apparatus 10

The tire belt B is manufactured as follows using the manufacturing apparatus 10 configured as described above.

As shown in FIG. 1, the front rubber member 1af is disposed such that the uncut side 1a1 thereof on the back side X2 in the first direction X is located at the joining position P, and is disposed so as to cover part of the conveyer belts 61f, 62f, 63f, 64f of the plurality of conveyers 61, 62, 63, 64 in a width direction (second direction Y).

The supply device 20 pulls the raw belt 1 from the supply drum 21 by the predetermined length, and then, supplies the raw belt 1 to the formation unit 40. Thereafter, the cutting device 30 cuts the raw belt 1, thereby forming the rubber member 1a on the formation unit 40. Then, the formation unit 40 conveys the rubber member 1a to the conveyer 60 of the joining table 50.

The rubber member 1a conveyed from the formation unit 40 to the conveyer 60 is placed on the conveyer 60 such that the acute-angled portion of the rubber member 1a on the front side X1 in the first direction X is conveyed by the first conveyer 61 having the longest conveyance unit. Then, the rubber member 1a is conveyed to the front side X1 in the first direction X by the plurality of conveyers 61, 62, 63, 64 forming the conveyer 60.

The rubber member 1a conveyed to the front side X1 in the first direction X is the back rubber member lab to be joined to the front rubber member 1af. The rubber member 1a conveyed to the front side X1 in the first direction X is disposed such that the uncut side 1a1 thereof on the front side X1 in the first direction X is located at the joining position P. Accordingly, the uncut side 1a1 of the front rubber member 1af and the uncut side 1a1 of the back rubber member lab face each other at the joining position P.

Then, the pair of joining rollers 81 of the joining device 80 moves along the uncut sides 1a1 of the front rubber member 1af and the back rubber member lab disposed at the joining position P. Accordingly, the pair of joining rollers 81 pulls the end portions of both these rubber members 1af, lab, and joins the uncut sides 1a1 in a state of these uncut sides 1a1 contacting each other. In this manner, the tire belt B is formed.

Then, after completion of joining of the back rubber member lab to the front rubber member 1af, the discharge device 90 moves the tire belt B to the front side X1 in the first direction X by the length of the joined back rubber member lab in the first direction X such that the back uncut side 1a1 of the front rubber member 1af in the first direction X is located at the joining position P.

Thereafter, a process of forming the rubber member 1a by cutting the raw belt 1, a process of conveying the rubber member 1a to the joining position P, and a process of joining the front rubber member 1af and the back rubber member lab as described above are repeated, and in this manner, the tire belt B is manufactured.

### (6) Effects

In the present embodiment, the plurality of conveyers 61, 62, 63, 64 forming the conveyer 60 is disposed in such a stepwise manner that the conveyer belt disposed closer to the one side Y1 in the second direction Y is located closer to the front side X1 in the first direction X. The parallelogram rubber member 1a is placed on the conveyer 60 such that the acute-angled portion of the rubber member 1a on the front side X1 in the first direction X is conveyed by the first conveyer 61, so that the drive force of the conveyer 60 can also be easily transmitted to the front portion of the rubber member 1a in the first direction X and misalignment can be reduced accordingly.

In a case where the plurality of conveyers 61, 62, 63, 64 is driven by the same drive device 65 as in the present embodiment, the plurality of conveyers 61, 62, 63, 64 can be easily synchronized with each other, and the conveyer 60 can be easily controlled accordingly.

In a case where all the back pulleys 61a, 62a, 63a, 64a and the front pulleys 61b, 62b, 63b, 64b provided on both sides of the conveyance units 61f1, 62f1, 63f1, 64f1 have the same outer diameter as in the present embodiment, all the conveyer belts 61f, 62f, 63f, 64f can revolve at the same speed, and movement of the rubber member 1a in a direction other than the first direction X can be prevented even in a case where the conveyer 60 includes the plurality of conveyers.

In a case where the suction units 61g, 62g, 63g, 64g are more densely provided on the front side X1 of the conveyance units 61f1, 62f1, 63f1, 64f1 in the first direction X than on the back side X2 in the first direction X as in the present embodiment, the acute-angled portion of the rubber member 1a on the front side X1 in the first direction X is held and is less likely to move in a direction other than the first direction X.

In a case where the back pulleys 61a, 62a, 63a, 64a and the front pulleys 61b, 62b, 63b, 64b have greater diameters at the center portions than both end portions in the rotation axis direction as in the present embodiment, movement of the conveyer belts 61f, 62f, 63f, 64f in the width direction (second direction Y) during running can be reduced.

In a case where the joining position P is set so as to cross the opposing portions 70a, 70b, 70c, 70d of the support unit 70 in plan view and the front rubber member 1af is disposed so as to cover part of the conveyer belts 61f, 62f, 63f, 64f in the width direction as in the present embodiment, the conveyer 60 can apply the drive force to the back rubber member lab until immediately before the uncut side 1a1 of the back rubber member lab reaches the joining position P, and the back rubber member lab can be stably conveyed to a predetermined position.

### REFERENCE SIGNS LIST

1: raw belt
1a: rubber member
1a1: uncut side
1a2: cut side
10: tire belt manufacturing apparatus (including 20, 30, 40, 50, 80)
20: supply device
21: supply drum
22: supply conveyer
30: cutting device
40: formation unit
50: joining table
60: conveyer
60a: support shaft
61: first conveyer
61a: back pulley
61b: front pulley
61c: drive pulley
61d: bend pulley
61e: adjustment pulley
61f: conveyer belt
61f1: conveyance unit
61g: suction unit
62: second conveyer
62a: back pulley
62b: front pulley
62c: drive pulley
62d: bend pulley
62e: adjustment pulley
62f: conveyer belt
62f1: conveyance unit
62g: suction unit
63: third conveyer
63a: back pulley
63b: front pulley
63c: drive pulley
63d: bend pulley
63e: adjustment pulley
63f: conveyer belt
63f1: conveyance unit
63g: suction unit
64: fourth conveyer
64a: back pulley
64b: front pulley
64c: drive pulley
64d: bend pulley
64e: adjustment pulley
64f: conveyer belt
64f1: conveyance unit
64g: suction unit
65: drive device
65a: drive shaft
70: support unit
80: joining device
90: discharge device
B: tire belt
D: conveyance direction
P: joining position
X: first direction
X1: front side in first direction
X2: back side in first direction
Y: second direction

What is claimed is:

1. A tire belt manufacturing apparatus comprising:
a joining table on which at least one parallelogram rubber member is to be placed and that moves the rubber member to a front side in a first direction; and
a joining device that joins sides of the rubber members,
wherein the joining device joins a side of the rubber member, which is placed on the front side of a joining position set for the joining table in the first direction, on a back side in the first direction to a side of the rubber member, which is placed on the back side of the joining position in the first direction, on the front side in the first direction to manufacture a tire belt,
the joining table includes a conveyer that moves the rubber member to the front side in the first direction and conveys the rubber member to the back side of the joining position in the first direction, and a support unit that supports the rubber member placed on the front side of the joining position in the first direction, and
the conveyer includes a plurality of conveyer belts extending in the first direction and provided side by side in a second direction perpendicular to the first direction, and the plurality of conveyer belts is disposed in such a stepwise manner that the conveyer belt disposed closer to one side in the second direction is located closer to the front side in the first direction.

2. The tire belt manufacturing apparatus according to claim 1, wherein
the plurality of conveyer belts is driven by an identical drive device.

3. The tire belt manufacturing apparatus according to claim 1, wherein
the conveyer includes, for each of the plurality of conveyer belts, pulleys disposed at both end portions of a conveyance unit that conveys the rubber member, and
the plurality of conveyer belts has an identical pulley diameter.

4. The tire belt manufacturing apparatus according to claim 1, wherein
the rubber member placed on the front side of the joining position in the first direction is disposed so as to cover part of the plurality of conveyer belts in a width direction.

5. The tire belt manufacturing apparatus according to claim 1, wherein
the conveyer includes a plurality of suction units that sucks the rubber member at an interval in the first direction, and the suction units are more densely provided on the front side in the first direction than on the back side in the first direction.

6. The tire belt manufacturing apparatus according to claim 1, wherein
the conveyer includes, for each of the plurality of conveyer belts, pulleys disposed at both end portions of a conveyance unit that conveys the rubber member, and
each of the pulleys has a greater diameter at a center portion in a rotation axis direction than at both end portions in the rotation axis direction.
